(19) United States
(12) Patent Application Publication
(10) Pub. No.: US 2026/0149626 A1
(43) Pub. Date: May 28, 2026

(54) METHOD AND APPARATUS FOR ESTIMATING CHANNEL CHARACTERISTICS OF FREQUENCY BAND FOR DELAY SPREAD ESTIMATION IN WIRELESS COMMUNICATION SYSTEM

(71) Applicant: SAMSUNG ELECTRONICS CO., LTD., Suwon-si (KR)

(72) Inventors: Hyeonwoong KIM, Suwon-si (KR); Hyuntack LIM, Suwon-si (KR); Youngkwan CHOI, Suwon-si (KR); Sangheon KIM, Suwon-si (KR)

(73) Assignee: SAMSUNG ELECTRONICS CO., LTD., Suwon-si (KR)

(21) Appl. No.: 19/402,151

(22) Filed: Nov. 26, 2025

Related U.S. Application Data
(63) Continuation of application No. PCT/KR2025/019749, filed on Nov. 26, 2025.

(30) Foreign Application Priority Data
Nov. 28, 2024 (KR) 10-2024-0174205

(51) Int. Cl. H04L 25/02; H04B 17/20

(52) U.S. Cl. CPC H04L 25/0254; H04B 17/201

(57) ABSTRACT

A method and an apparatus for estimating a channel characteristic in a wireless communication system is provided. The method includes estimating, based on input data, channel characteristic of a reception channel by using a plurality of dilated convolution blocks with a parallel connection structure in a convolution neural network (CNN) based model, and estimating, based on the estimated channel characteristic, a delay spread level of the reception channel.

### CROSS-REFERENCE TO RELATED APPLICATION(S)

This application is a continuation of an International Application No. PCT/KR2025/019749, filed on Nov. 26, 2025, which is based on and claims priority to Korean Patent Application No. 10-2024-0174205, filed on Nov. 28, 2024, in the Korean Intellectual Property Office, and the disclosures of which are incorporated by reference herein in their entireties.

### BACKGROUND

### 1. Field

The disclosure relates to a method and an apparatus for estimating a channel characteristic in a wireless communication system.

### 2. Description of Related Art

In order to meet the demand for wireless data traffic, which has been increasing since the fourth-generation (4G) system (e.g., a Long-Term Evolution (LTE) system), a fifth (5G) system (e.g., a New Radio (NR) system) has been developed and commercialized. The 5G system may be implemented in an extremely high frequency (mm Wave) band. To relieve the path loss of radio signals and to increase the transmission distance of radio signals in the extremely high frequency band, beamforming, massive multiple-input and multiple-output (massive MIMO), full dimensional MIMO (FD-MIMO), array antenna, analog beamforming, and large-scale antenna techniques are under discussion for the 5G system.

In wireless communication systems, such as the 4G system and the 5G system, orthogonal frequency-division multiplexing (OFDM) used, since OFDM is robust with respect to interference between signals and frequency selective fading, and thus is suitable for wideband signal transmission. Frequency selective fading is a type of fading (e.g., signal attenuation) phenomenon that occurs in a multipath communication environment, and refers to a phenomenon in which a signal is strongly affected only in a specific frequency band as different frequency components are attenuated to different degrees. Frequency selective fading mostly occurs in a communication environment in which delay spread caused by multiple paths is severe, and due to frequency selectivity, a transmission signal may be weakened in some frequency bands among all frequency bands and may be strongly received in other frequency bands in a wireless communication system.

Since the overall performance of an OFDM-based communication system is directly affected by channel estimation performance in the frequency domain, various algorithms for enhancing the overall performance of the communication system by efficiently analyzing a channel characteristic in the frequency domain are being studied. For example, to improve channel estimation performance in the frequency domain, it is important for a communication device to extract a frequency-selective characteristic of reception channel and to design an optimal filter accordingly. In addition, improved channel estimation performance in a wireless communication system may lead to improved cell coverage and throughput.

Since frequency-selective characteristics of multipath channels in a wireless communication system are strongly correlated with delay spread of a reception channel, it is necessary to properly estimate the delay spread to improve the reception performance of a communication device, such as a base station and a user equipment (UE), which perform communication through channel estimation.

### SUMMARY

One or more aspects of the disclosure provides a method and an apparatus for estimating a channel characteristic of a frequency band, based on artificial intelligence (AI), and estimating delay spread in a wireless communication system based on the estimated channel characteristic of the frequency band.

One or more aspects of the disclosure provides a method and an apparatus for efficiently estimating a channel characteristic, based on AI, for a communication device using least square (LS) channel estimation, and estimating delay spread in a wireless communication system based on the estimated channel characteristic.

According to an aspect of the disclosure, there is provided a method performed by a communication device in a wireless communication system. The method may include obtaining, for a reception channel, a channel matrix in a frequency domain estimated using a least square (LS) channel estimation scheme. The method may include configuring input data of a convolution neural network (CNN)-based model for estimating a channel characteristic of the reception channel from the channel matrix. The method may include estimating, based on the input data, the channel characteristic of the reception channel by using a plurality of dilated convolution blocks with a parallel connection structure in the CNN-based model. The method may include estimating, based on the estimated channel characteristic, a delay spread level of the reception channel.

The method may further include performing iterative training of the CNN-based model by using the plurality of dilated convolution blocks with the parallel connection structure.

The performing the iterative training may be terminated based on convergence of validation loss of the CNN-based model.

The estimating the channel characteristic may include extracting the channel characteristic through a plurality of receptive fields of the plurality of dilated convolution blocks.

The plurality of dilated convolution blocks with the parallel connection structure may be configured based on different dilation rates indicating distribution degree of a receptive field in the frequency domain.

The configuring of the input data may further include performing a one-dimensional (1D) pointwise convolution operation for resizing of the input data, based on a number of the plurality of dilated convolution blocks.

An active mode of the communication device may include a training mode and an operation mode, and the method may further include in the training mode: performing iterative training of estimating the channel characteristic and estimating the delay spread level; and in the operation mode: estimating the channel characteristic of the reception channel by using the CNN-based model trained and estimating the delay spread level based on the estimated channel characteristic in case that the iterative training is performed a predetermined number of times.

The method may further include performing additional training of the CNN-based model based on actual channel data collected by the communication device as input data in the operation mode.

The delay spread level may be classified into a plurality of levels depending on delay spread degree.

The method may further include concatenating channel characteristic data of the reception channel output from the plurality of dilated convolution blocks; and outputting a probability value that the channel characteristic of the reception channel belongs to the delay spread level, based on the channel characteristic data.

According to another aspect of the disclosure, there is provided a communication device in a wireless communication system, the communication device including: one or more processors including processing circuitry; and memory storing instructions that, when executed by the one or more processors individually or collectively, cause the communication device to obtain, for a reception channel, a channel matrix in a frequency domain estimated using least square (LS) channel estimation method. The instructions, when executed by the one or more processors individually or collectively, may further cause the communication device to configure input data of a convolution neural network (CNN)-based model for estimating a channel characteristic of the reception channel from the channel matrix. The instructions, when executed by the one or more processors individually or collectively, may further cause the communication device to estimate, based on the input data, the channel characteristic of the reception channel by using a plurality of dilated convolution blocks with a parallel connection structure. The instructions, when executed by the one or more processors individually or collectively, may further cause the communication device to estimate, based on the estimated channel characteristic, a delay spread level of the reception channel.

The instructions, when executed by the one or more processors individually or collectively, may further cause the communication device to: perform iterative training of the CNN-based model by using the plurality of dilated convolution blocks with the parallel connection structure.

The instructions, when executed by the one or more processors individually or collectively, may further cause the communication device to: terminate the iterative training based on convergence of validation loss of the CNN-based model.

The instructions, when executed by the one or more processors individually or collectively, may further cause the communication device to: extract the channel characteristic through a plurality of receptive fields of the plurality of dilated convolution blocks.

The instructions, when executed by the one or more processors individually or collectively, may further cause the communication device to: configure different dilation rates indicating distribution degree of a receptive field in the frequency domain for the plurality of dilated convolution blocks.

The instructions, when executed by the one or more processors individually or collectively, may further cause the communication device to: perform a one-dimensional (1D) pointwise convolution operation for resizing of the input data, based on a number of the plurality of dilated convolution blocks.

An active mode of the communication device may include a training mode and an operation mode, and the instructions, when executed by the one or more processors individually or collectively, may further cause the communication device to: in the training mode: perform iterative training of estimating the channel characteristic and estimating the delay spread level in the training mode; and in the operation mode: estimate the channel characteristic of the reception channel by using the CNN-based model trained and estimate the delay spread level, based on the estimated channel characteristic when the iterative training is performed a predetermined number of times.

The delay spread level may be classified into a plurality of levels depending on delay spread degree.

The instructions, when executed by the one or more processors individually or collectively, may further cause the communication device to: concatenate channel characteristic data of the reception channel output from the plurality of dilated convolution blocks; and output a probability value that the channel characteristic of the reception channel belongs to the delay spread level, based on the channel characteristic data.

The instructions, when executed by the one or more processors individually or collectively, may further cause the communication device to: perform additional training of the CNN-based model by using actual channel data collected by the communication device as input data in the operation mode.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustrative drawings. Embodiments herein are illustrated by way of examples in the accompanying drawings, and in which:

FIG. 1 illustrates an example of a basic structure of time-frequency resources in a 5G system.

FIG. 2 illustrates an example of a structure of a frame, a subframe, and a slot in a 5G system.

FIG. 3 illustrates an example of a bandwidth part configuration in a 5G system.

FIG. 4 illustrates an example of a method of estimating a channel characteristic by a communication device in a wireless communication system according to an embodiment;

FIG. 5 illustrates an example of a method of estimating a channel characteristic by a communication device according to an embodiment of the disclosure;

FIG. 6 illustrates an example of a dilated convolution filter used in a CNN-based model for estimating a channel characteristic in a communication device according to an embodiment of the disclosure;

FIG. 7 illustrates an example of the configuration of a CNN-based model including a plurality of dilated convolution blocks in a parallel connection structure according to an embodiment of the disclosure;

FIG. 8 illustrates an example of the configuration of a dilated convolution block (DCB) included in the CNN-based model of FIG. 7;

FIG. 9 illustrates an example of the configuration of a fully connected block (FCB) included in the CNN-based model of FIG. 7;

FIG. 10 illustrates an example of a method in which a communication device estimates a channel characteristic by using a CNN-based model to estimate delay spread according to an embodiment of the disclosure;

FIG. 11 and FIG. 12 illustrate examples of simulation results of delay spread estimation performance using a CNN-based model according to an embodiment of the disclosure; and

FIG. 13 illustrates an example of a structure of a communication device in a wireless communication system according to an embodiment of the disclosure.

### DETAILED DESCRIPTION

Hereinafter, the operation principle of the disclosure will be described in detail in conjunction with the accompanying drawings. In addition, a detailed description of known functions or configurations that may make the subject matter of the disclosure unclear will be omitted. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

As used herein, a base station (BS) refers to a network entity capable of allocating resources to terminals and communicating with the terminals through a wireless network, and may be at least one of an eNode B, a Node B, a gNB, a radio access network (RAN), an access network (AN), an RAN node, an integrated access/backhaul (IAB) node, a wireless access unit, a base station controller, a node on a network, or a transmission reception point (TRP). A user equipment (UE) may be at least one of a terminal, a mobile station (MS), a cellular phone, a smartphone, a computer, or a multimedia system capable of performing a communication function.

In the following description, some of terms and names defined in the 3GPP NR standards may be used for the sake of descriptive convenience. However, the disclosure is not limited by these terms and names, and may be applied in the same way to systems that conform other standards.

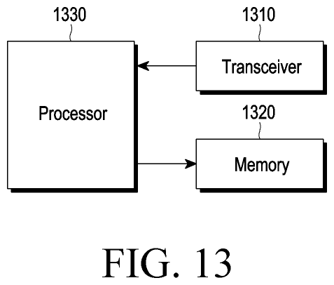

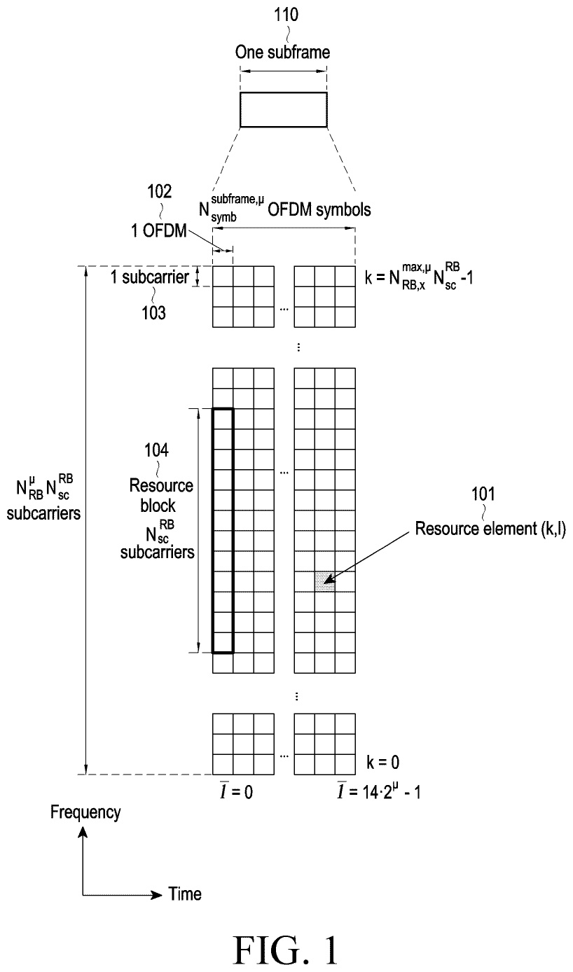

FIG. 1 illustrates an example of a basic structure of time-frequency resources in a 5G communication system.

In FIG. 1, the horizontal axis represents a time domain, and the vertical axis represents a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain

$${N}_{SC}^{RB} ,$$

for example, 12 consecutive REs may constitute one resource block (RB) 104. In an embodiment, a plurality of OFDM symbols may constitute one subframe 110. In FIG. 1,

$${N}_{symb}^{subframe , μ}$$

is the number of OFDM symbols per subframe 110 for a subcarrier spacing configuration (μ), and a more detailed description of the resource structure in the 5G system may refer to section 4 of TS 38.211 (5G standard).

The RE 101 may be represented by an OFDM symbol index and a subcarrier index. The RB 104 may be defined as

$${N}_{SC}^{RB}$$

consecutive subcarriers. The resource block RB 101 may be referred to as physical resource block (PRB). In the 5G system,

$${N}_{SC}^{RB} = 12 ,$$

and a data rate may be increased proportionally to the number of RBs scheduled for a UE. In a wireless communication system, a base station may map data in units of RBs, and may generally schedule RBs constituting one slot for a UE. That is, the basic time unit to perform scheduling in the 5G system may be a slot, and the basic frequency unit to perform scheduling may be an RB.

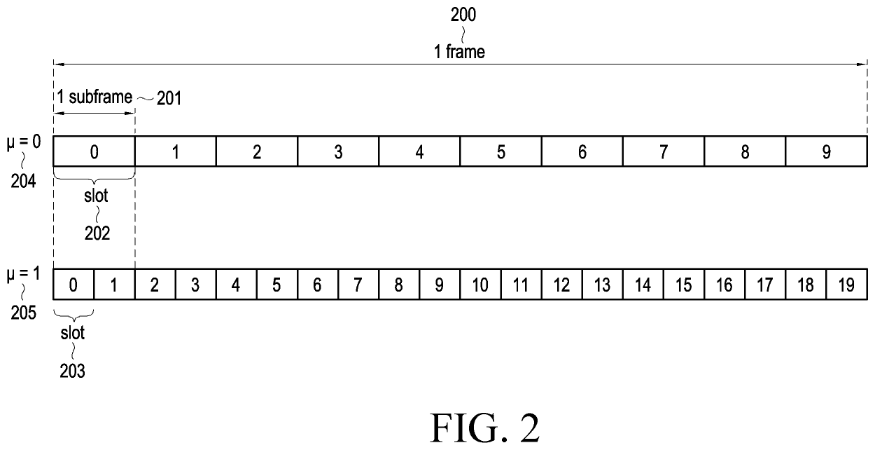

FIG. 2 illustrates an example of a structure of a frame, a subframe, and a slot in a 5G system.

Referring to FIG. 2, one frame 200 may include one or more subframes 201, and one subframe may include one or more slots 202. For example, one frame 200 may be defined as 10 ms. One subframe 201 may be defined as 1 ms, and in this case, one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values u for the subcarrier spacing 204 or 205. The example of FIG. 2 shows the case of μ=0 (204) and the case of μ=1 (205) as the subcarrier spacing configuration value. For example, in the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

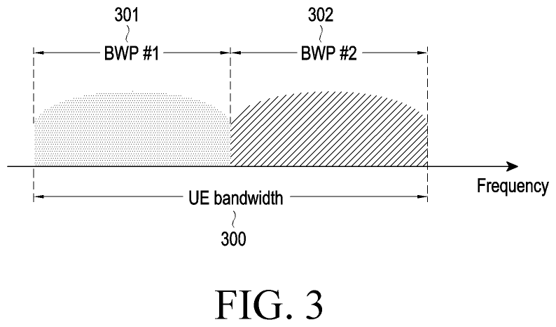

FIG. 3 illustrates an example of a bandwidth part (BWP) configuration in a 5G system;

FIG. 3 illustrates an example in which a UE bandwidth 300 is configured to include two bandwidth parts, for example, bandwidth part #1 (BWP #1) 301 and bandwidth part #2 (BWP #2) 302. However, the disclosure is not limited thereto, and as such, a base station may configure one or multiple BWPs for a UE, and may configure the following pieces of information with regard to each BWP as given below. For example, “locationAndBandwidth” refers to the location and bandwidth of a corresponding bandwidth part in the frequency domain, “subcarrierSpacing” refers to a subcarrier spacing to be used in the corresponding bandwidth part, and “cyclicPrefix” refers to whether an extended cyclic prefix (CP) is used for the corresponding bandwidth part.

In the 5G system, the base station may configure, for example, four DL BWPs for the UE, and may activate one DL BWP among the four DL BWPs. In addition, the base station may configure, for example, four UL BWPs for the UE, and may activate one UL BWP among the four UL BWPs.

The above example is not limiting, and various parameters related to the BWP may be configured for the UE, in addition to the above configuration information. The base station may transfer the configuration information to the UE through upper layer signaling, for example, radio resource control (RRC) signaling. According to an embodiment, one configured BWP or at least one of multiple configured BWPs may be activated. According to an embodiment, information on whether or not the configured bandwidth part is activated may be transferred from the base station to the UE semi-statically through RRC signaling, or dynamically through downlink control information (DCI).

The BWP-related configuration supported by 5G may be used for various purposes.

According to some embodiments, in an example case in which the bandwidth supported by the UE is smaller than the system bandwidth, this may be supported through the BWP configuration. For example, the base station may configure the frequency location of the BWP for the UE, so that the UE can transmit/receive data at a specific frequency location within the system bandwidth.

In addition, according to some embodiments, the base station may configure multiple BWPs for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing (FDM), and if data is to be transmitted/received at a specific subcarrier spacing, the BWP configured as the corresponding subcarrier spacing may be activated.

Recently, neural network-based algorithms through massive data learning has been implemented in various technical fields including communication system. For example, network-based algorithms and AI-based techniques suitable for next-generation mmWave-band or THz-band communication system structures, such as a 5G system or a 6G system, are being proposed and researched. Recently, various AI-based optimization techniques have been attracting attention to effectively solve a problem in estimating a reception channel in wireless communication systems.

Hereinafter, a method in which a communication device performing channel estimation estimates delay spread as a channel characteristic of a frequency band, based on AI in a wireless communication system will be described.

Related art channel estimation methods used for a communication device, such as a base station and a UE, include a least square (LS) estimation method and a minimum mean square error (MMSE) estimation method.

The LS estimation scheme is a scheme for estimating a channel characteristic that minimizes the difference between a reference signal (or pilot signal) for channel estimation known between a transmitting device and a receiving device and a reception signal. The LS estimation scheme is relatively simple to implement in a communication device and has low computational complexity, and is thus widely used in real-time communication systems. However, the LS estimation scheme may have poor performance in a communication environment where delay spread or noise makes a significant impact. The MMSE estimation method is a method that minimizes a channel estimation error by considering both noise and a statistical characteristic of a channel. The MMSE estimation method guarantees stable channel estimation performance in a communication environment with high noise, but has high computational complexity.

According to an embodiment, a method of estimating a channel characteristic of a frequency band, based on AI, is provided to reduce the impact of delay spread when a communication device, such as a base station, that uses the LS estimation scheme for low complexity as a channel estimation method estimates a channel. According to the method according to an embodiment of the disclosure, it is possible to minimize a decrease in communication performance due to delay spread while using the LS estimation scheme with low complexity.

An example of an AI model available to estimate a channel characteristic in a frequency band based on AI is a convolution neural network (CNN)-based model. For example, a CNN-based model shows excellent performance in a computer vision field. A CNN may process input data in a frequency domain through various types of operations in a network, may extract a feature of the input data, and may finally generate a result for classification or prediction. In an example case in which a channel characteristic is estimated using the AI model, the input data may include, for example, an in-phase (I) channel signal and a quadrature (Q) channel signal (hereinafter, referred to as IQ signals) in the frequency domain.

The CNN is a neural network designed to be suitable mainly for two-dimensional data, such as an image, in which a plurality of layers may be combined to form a hierarchical structure. The CNN may process various input data and extract a useful feature from the input data by using two elements of a receptive field and a convolution filter. The convolution filter includes a matrix that detects/estimates a specific pattern of input data, and may be used to learn a local pattern of the input data. The CNN may extract a feature of input data by using a plurality of convolution filters in the plurality of layers. The receptive field refers to an area of data recognizable at once by the convolution filter. As input data passes through the plurality of layers in the CNN, the area of data (e.g., the receptive field) recognizable by the convolution filter may gradually dilate. The CNN may gradually and accurately detect/estimate a specific pattern of input data by using the plurality of convolution filters.

In related art CNN-based models, such as residual network (ResNet) and visual geometry group network (VGGNet) structures, a feature(s) of input data may be extracted and learned by configuring convolution filters of all layers to the same size and deeply stacking the convolution layers. Specifically, in the CNN-based models, as the input data passes through the layers, from low-level to high-level features are extracted by a convolution operation of the convolution filters, and the CNN-based model may learn model parameters such that a preset loss function is minimized by using the extracted feature(s).

According to a characteristic of the CNN structures which extract a data characteristic by performing a convolution operation, an area of data (receptive field) processed by a convolution filter is dilated as input data passes through a plurality of layers. Among the CNN-based models, a method of stacking relatively deep layers generally show excellent performance.

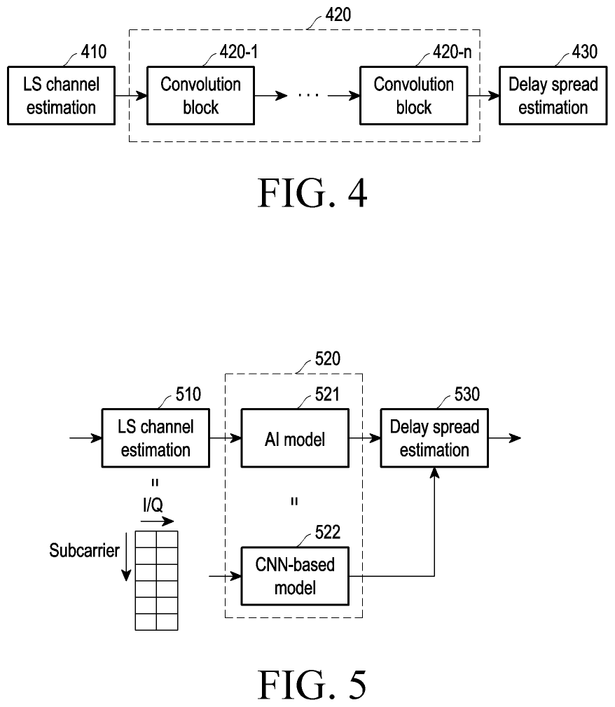

FIG. 4 illustrates an example of a method in which a communication device using an LS channel estimation scheme estimates a channel characteristic by using a CNN-based model and estimates delay spread in a frequency band according to the estimated channel characteristic in a wireless communication system.

Referring to FIG. 4, the communication device performs channel estimation by using the LS channel estimation scheme (410). In explaining the LS channel estimation scheme, assuming that a channel matrix or channel vector to be estimated in a channel estimation process using a reference signal (or pilot signal) is H, a symbol vector of a transmission signal (e.g., the reference signal or pilot signal) is x, a noise signal vector is n, and a reception signal vector is y, y may be expressed below as Equation 1.

$$y = H x + n \qquad [ Equation 1 ]$$

The channel estimation is a process of estimating the channel matrix H representing a channel characteristic in Equation 1. In the LS channel estimation scheme, the channel matrix H that minimizes the square of the error (y-Hx) between a signal (Hx) transmitted through a channel and a signal (y) received by the communication device may be estimated in the following Equation 2. In Equation 2, ∥·∥² is a norm operation of a vector.

$$Error = {‖ y - Hx ‖}^{2} \qquad [ Equation 2 ]$$

In an example case in which the communication device is a base station, the base station may estimate an initial channel matrix H of a reception channel through which an uplink signal transmitted by a UE is received by the foregoing method. For example, the uplink signal may be a reference signal for channel estimation. In a communication system, a channel matrix has a complex value for each subcarrier in a frequency domain, and may be expressed as an I/Q signal including amplitude and phase information in each subcarrier. The channel matrix reflects a frequency-selective characteristic due to multipath fading between a transmitter and a receiver.

After performing the (initial) channel estimation with the LS channel estimation scheme, the communication device may analyze an estimated channel characteristic (e.g., a spatial characteristic of channel data) by using a CNN-based model with a deep layer (420), and may use spatial characteristic information about a channel from the analysis to estimate the delay spread of the channel (430). The communication device may obtain a complemented/modified channel matrix by applying a filter for complementing the estimated delay spread to the channel matrix in order to reduce the impact of interference/noise in the estimated channel matrix for the reception channel.

Methods for dilating a receptive field of a CNN structure include a method of deeply stacking convolution layers and a method of increasing the size of a convolution filter. The example of FIG. 4 shows a method of deeply stacking convolution layers by connecting a plurality of convolution blocks 420-1, . . . , 420-n in series. As shown in FIG. 4, an area (receptive field) of the data processed by a convolution filter may be dilated by the method of deeply stacking the convolution layers, thereby improving the performance of channel characteristic estimation. However, in an example case in which convolution layers are deeply stacked or the size of a convolution filter is increased, the number of parameters to be processed by the communication device increases, thus increasing computational complexity (e.g., computation quantity) in channel characteristic estimation. In a next-generation wireless communication system that requires real-time signal processing and stability therefor, an increase in computational complexity may cause a decrease in the overall performance of the communication system.

According to an embodiment of the disclosure, a CNN-based model with a new structure is provided. The CNN-based model according to an embodiment of the disclosure is capable of improving the performance of channel characteristic estimation without using a structure that dilates a receptive field by connecting a plurality of convolution blocks in series as in the example of FIG. 4. The CNN-based model according to an embodiment of the disclosure reduces the computational complexity of a CNN-based model that estimates a channel characteristic of a frequency band in a communication device using an LS channel estimation scheme. According to one or more embodiments of the disclosure described below, a CNN-based model may use convolution (filter) blocks in a parallel connection structure suitable for delay spread estimation of a multi-path channel, and may provide improved channel characteristic estimation performance with low computational complexity compared to a related art CNN-based model using convolution (filter) blocks in a series connection structure.

According to an embodiment of the disclosure, in an example case in which a communication device that performs channel estimation using an LS channel estimation scheme estimates a channel characteristic for delay spread estimation in an orthogonal frequency-division multiplexing (OFDM)-based wireless communication system. One or more embodiments of the disclosure may provide a method suitable for a communication device to extract a channel characteristic in a frequency band, based on AI in real time.

FIG. 5 illustrates an example of a method in which a communication device using an LS channel estimation scheme estimates a channel characteristic of a frequency band by using a CNN model to estimate delay spread according to an embodiment of the disclosure.

Referring to FIG. 5, in operation (510), the method according to an embodiment may include a data configuration operation of configuring a channel matrix in a frequency domain initially estimated by the LS channel estimation scheme into a format of input data of an AI model according to an embodiment of the disclosure. In operation (520), the method according to an embodiment may include training an AI model to estimate a channel characteristic by using the configured input data. In operation (530), the method according to an embodiment may include estimating a delay spread level of a reception channel by using the channel characteristic estimated through the AI model. According to an embodiment, AI model 521 refers to a pre-trained AI model 521 which has been completely trained for convenience of explanation, and operations 510 to 530 may be repeatedly performed, for example, a preset number of times for estimating a channel characteristic, by a communication device, such as a base station. According to an embodiment, element, the AI model 521 may use a CNN-based model 522 including a plurality of dilated convolution filters in a parallel connection structure. According to an embodiment, the AI model 521 which has been completely trained and the CNN-based model 522 may be understood to be the same.

Referring in detail the method of FIG. 5, in operation 510, the communication device may reconfigure the channel matrix initially estimated by the LS channel estimation scheme in accordance with the format of the input data of the AI model considering a pre-training operation of the AI model proposed in the disclosure. For example, the channel matrix has a complex value for each subcarrier in the frequency domain, and may be expressed as an I/Q signal including amplitude and phase information in each subcarrier. In operation 510, the communication device may obtain the channel matrix by separating and metricizing I-channel components and Q-channel components of channel coefficients for each subcarrier, and may configure the input data for pre-training the AI model according to an embodiment of the disclosure from the obtained channel matrix through a resizing operation in view of the number of convolution filters (or convolution blocks) in the AI model.

According to an embodiment, the input data may further include information about a delay spread level estimated in previous learning in an iterative training process of the AI model, which may be used for the AI model to improve the estimation accuracy of the channel characteristic. The information about the delay diffusion level estimated in the previous learning may be used as key information for improving the estimation accuracy of the AI model. For example, the key information may be included in the input data in iterative training for estimation by delay spread level as illustrated below in Table 1, and the iterative training may be performed so that a channel characteristic estimation result of the AI model matches the key information.

In operation 520, the communication device may iteratively train the AI model using the plurality of dilated convolution filters in the parallel connection structure to minimize the value of a loss function suitable for delay spread estimation by using the input data configured in operation 510. The communication device may train the AI model, that is, the CNN-based model, for a preset number of learning times (e.g., the number of epochs, where an epoch refers to a process in which the AI model learns the entire given input data once). In an example case in which validation loss for validating learning of the AI model converges, the communication device may terminate the iterative training, and may use the AI model with an optimal model weight value updated as the pre-trained AI model 521.

In operation 530, the communication device may estimate the delay spread of the reception channel in the frequency band by using the channel characteristic of the reception channel estimated using the pre-trained AI model 521. In an embodiment, the communication device may estimate the delay spread of the reception channel after the learning of the AI model is completed. In an embodiment, the communication device may also repeatedly estimate the delay spread of the reception channel during the iterative training process of the AI model. However, the disclosure is not limited thereto, and as such, according to an embodiment, the delay spread of the reception channel may also be estimated by including additional information, such as, but not limited to, signal-to-noise ratio (SNR) information, to the channel matrix estimated by the LS channel estimation scheme. In an embodiment, the delay spread may be estimated by estimating the delay spread level of the reception channel as a probability value. The delay spread level may be classified into a plurality of levels according to the degree of delay spread.

According to an example embodiment of the method illustrated in FIG. 5, the channel matrix initially estimated through the LS channel estimation scheme may not accurately estimate the reception channel due to the impact of interference/noise caused by delay spread in a communication environment. Therefore, the communication device may estimate the channel characteristic of the reception channel by applying the AI model 521 pre-trained through iterative training in a training mode to the CNN-based model 522 in an operation mode, and may estimate the delay spread by using the estimated channel characteristic. In the operation mode, the communication device may estimate the delay spread according to the channel characteristic and apply a filter for correcting the estimated delay spread to the estimated channel matrix, thereby obtaining a complemented/modified channel matrix.

According to an embodiment, although the method of FIG. 5 shows a method of training the AI model through iterative training using input data in the training mode, the disclosure is not limited thereto, and as such, according to an embodiment, it is also possible for the communication device to perform additional training of the CNN-based model 522 by using, as input data, channel data in a I/Q signal format newly collected in actual transmission and reception of a signal in the operation mode.

According to an embodiment of the disclosure, the communication device may operate separately in the training mode and the operation mode.

In an embodiment, in the training mode, the communication device may perform channel estimation by the LS channel estimation scheme using communication parameters given/configured in advance assuming delay spread according to multiple paths in various communication environments, and the AI model may perform iterative training of receiving input data in a predetermined format from an estimated channel matrix and estimating a channel characteristic. In an embodiment, the iterative training may be performed until the number of learning times of the AI model reaches a predetermined number (e.g., the number of epochs). In an embodiment, the iterative training may be performed until a predetermined channel quality considering the delay spread is reached.

In an embodiment, in the operation mode, when learning of the AI model is completed to obtain the pre-trained AI model 521, the communication device may use the pre-trained AI model 521 as the CNN-based model 522 in an actual communication environment. In the operation mode, the communication device may perform channel estimation by the LS channel estimation scheme, and may estimate the channel characteristic of the reception channel by using the CNN-based model 522 using the plurality of dilated convolution filters in the parallel connection structure. Subsequently, in the operation mode, the communication device may estimate the delay spread according to the channel characteristic and apply the filter for correcting the estimated delay spread to the estimated channel matrix, thereby obtaining the complemented/modified channel matrix.

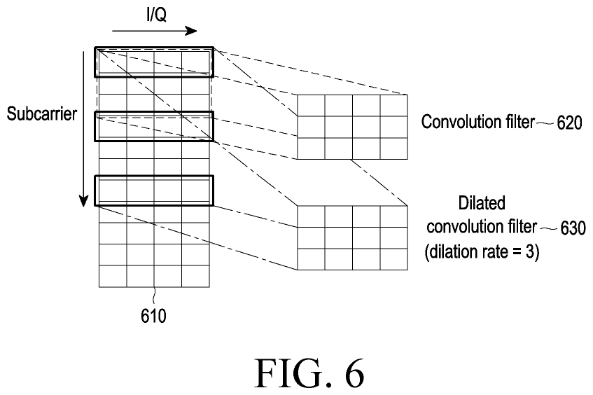

FIG. 6 illustrates an example of a dilated convolution filter used in a CNN-based model for estimating a channel characteristic in a communication device according to an embodiment of the disclosure.

According to an embodiment of the disclosure, a supervised learning-based CNN model specialized in extracting a high-dimensional data characteristic may be used to estimate a channel-selective characteristic in the frequency domain. The CNN-based model according to an embodiment of the disclosure may analyze a spatial characteristic of a channel matrix estimated for a reception channel in a plurality of receptive fields, and may reflect the spatial characteristic in estimating delay spread of the reception channel.

Referring to FIG. 6, a channel matrix estimated by the communication device through the LS channel estimation scheme may have a complex value for each subcarrier in the frequency domain as indicated by reference number 610, and may be expressed as an I/Q signal including amplitude and phase information in each subcarrier. A convolution filter 620 used in the related art CNN-based model has a receptive field in a local structure including, for example, a predetermined number of consecutive subcarriers (e.g., three consecutive subcarriers in FIG. 6) in the frequency domain. A dilated convolution filter 630 used in the CNN-based model according to an embodiment of the disclosure may have a receptive field including, for example, a predetermined number of distributed subcarriers (e.g., three distributed subcarriers in FIG. 6) in the frequency domain. The dilated convolution filter 630 shows that spacing between the subcarriers (e.g., the degree of distribution in the frequency domain) is 3 (e.g., the dilation rate=3). As in the example of FIG. 6, using the dilated convolution filter 630 makes it possible to reflect input data to a wide area of learning of the CNN model in the frequency domain while maintaining the number of operations the same as that the related art convolution filter 620.

The CNN-based model according to an embodiment of the disclosure has a structure using a plurality of dilated convolution filters, and the dilation rates of the plurality of dilated convolution filters may be configured to different values for delay spread estimation. Using the dilated convolution filter in the CNN-based model is more efficient for estimating a channel-selective characteristic which requires analyzing not only the relationship between adjacent frequency components but also the relationship between distant frequency components in estimation of a channel characteristic.

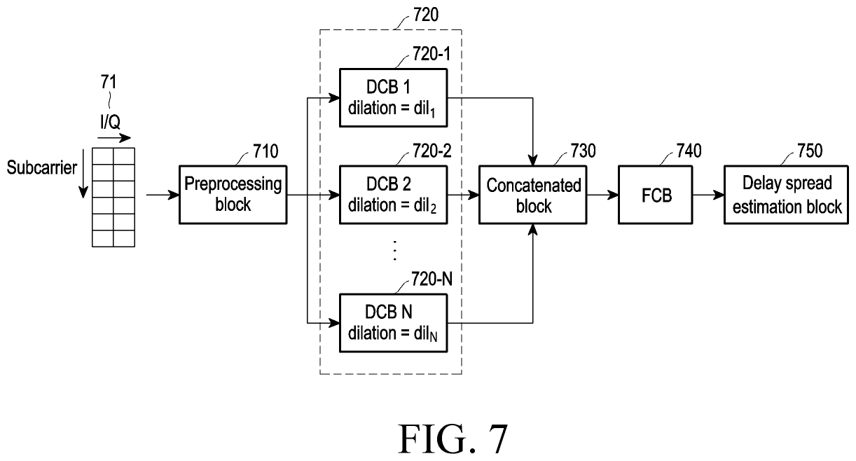

FIG. 7 illustrates an example of the configuration of a CNN-based model including a plurality of dilated convolution blocks in a parallel connection structure according to an embodiment of the disclosure. The CNN-based model illustrated in FIG. 7 may be included in a communication device, such as a base station, that uses the LS channel estimation scheme and used to estimate a channel characteristic in a frequency band for delay spread estimation.

Referring to FIG. 7, the CNN-based model according to an embodiment of the disclosure includes a convolution filter block 720 including the plurality of dilated convolution blocks (DCBs) DCB 1 720-1, DCB 2 720-2, . . . , and DCB N 720-N in a parallel connection structure. In an embodiment, the CNN-based model may further include at least one of a preprocessing block 710, a concatenated block 730, a fully connected block (FCB) 740, and a delay spread estimation block 750. For example, at least one of the preprocessing block 710, the concatenated block 730, the fully connected block (FCB) 740, and the delay spread estimation block 750 is linked to the convolution filter block 720.

According to an embodiment illustrated in FIG. 7, the plurality of blocks 710 to 750 may be configured to include memory which stores a program of the CNN-based model and a processor which controls the overall operation of the communication device according to the CNN-based model. In an embodiment, the communication device may further include a channel estimation block which performs channel estimation according to the LS channel estimation scheme. In an embodiment, the communication device may further include a transceiver for transmitting and receiving a radio signal. In an embodiment, the plurality of blocks 710 to 750 of the CNN-based model may be configured using a field-programmable gate array (FPGA). In an embodiment, the communication device may operate separately in the training mode and the operation mode according to the method of FIG. 5.

Referring to FIG. 7, the preprocessing block 710 may receive a channel matrix in the frequency domain estimated by the LS channel estimation scheme, and may perform a resizing operation based on the number of DCBs 720-1, . . . , and 720-N included in the convolution filter block 720. The resizing operation may use a 1D pointwise convolution operation, which is useful for reducing or dilating a channel axis in input data. According to an embodiment, the resizing operation may use a known 1D pointwise convolution operation, which is useful for reducing or dilating a channel axis in input data. The number of DCBs 720-1, . . . , and 720-N (or the number of convolution filters) that extract a channel characteristic of a reception channel may be adjusted through the resizing operation. The number of DCBs 720-1, . . . , and 720-N (or the number of convolution filters) may be adjusted or optimized as required by the communication device (or the CNN-based model).

The convolution filter block 720 receives the resized channel matrix data as input data. The convolution filter block 720 includes N DCBs 720-1, . . . , and 720-N in the parallel connection structure, and N dilation rates dil1, . . . , and dil_{N} may be configured for the DCBs 720-1, . . . , and 720-N so that a channel characteristic may be estimated in a wide area in the frequency domain considering a frequency-selective characteristic. In an embodiment, the N dilation rates may be configured to be different from each other. In an embodiment, at least some of the N dilation rates may be configured to be different from each other. In an embodiment, at least some of the N dilation rates may be configured to be same. In an embodiment, each of the DCBs 720-1, . . . , and 720-N may include at least one convolution filter.

The N DCBs 720-1, . . . , and 720-N are configured to extract a channel characteristic through a plurality of receptive fields by being connected in parallel instead of using a structure in which a plurality of convolution blocks is deeply connected in series to dilate a receptive field as in the example of FIG. 4. Using the convolution filter block 720 in the parallel connection structure makes it possible to improve channel characteristic estimation performance while reducing the computational complexity of the CNN-based model, compared to the serial connection structure of FIG. 4.

The concatenated block 730 concatenates/connects channel characteristic data of the reception channel extracted/output from the plurality of DCBs 720-1, . . . , and 720-N, and outputs the channel characteristic data to the fully connected block (FCB) 740.

The fully connected block (FCB) 740 outputs a probability value that the channel characteristic of the reception channel belongs to a preset delay spread level by using a softmax function used in a multi-classification model, which is a function that converts input data (e.g., channel characteristic data) into a probability value. According to an embodiment, it may also be possible to use another known function used in a multi-classification model that performs an operation equivalent to the softmax function.

The delay spread estimation block 750 estimates a delay spread level to which the estimated channel characteristic of the reception channel belongs, based on the probability value output from the FCB 740. The delay spread level may be classified into four levels according to the degree of delay spread, for example, as labeled in Table 1. However, the disclosure is not limited thereto, and as such a number of levels may be different than four. The communication device to which the CNN-based model of FIG. 7 is applied may apply a filter for correcting the delay spread to the channel matrix according to the estimated delay spread level, thereby obtaining a complemented/modified channel matrix with the impact of noise reduced. In an embodiment, in an example, case in which the communication device is a base station, the base station may perform LS channel estimation of each of uplink channels of a plurality of UEs by using the CNN-based model of FIG. 7, and may estimate delay spread for each UE, based on a channel characteristic of a channel of each UE estimated with low complexity.

TABLE 1

| Delay Spread [ns] | Label |
|---|---|
| τ_{Delay} ≤ 15 | Very Short (0) |
| 15 < τ_{Delay} ≤ 100 | Short (1) |
| 100 < τ_{Delay} ≤ 300 | Normal (2) |
| τ_{Delay} > 300 | Long (3) |

In the training mode of the CNN-based model using the dilated convolution filters in the parallel connection structure according to an embodiment of the disclosure, when defining a reception signal which the communication device receives in the frequency domain of the reception channel estimated by the LS channel estimation scheme as Y and the delay spread level as τ_{Delay}, the communication device may configure learning data by including the reception signal Y in the input data of the CNN-based model and including the delay spread level Delay estimated as a result of channel characteristic estimation learning using the reception signal Y as an output. The convolution filter block 720 of the CNN-based model may reflect all I/Q channel components of the input data in learning, and an example of the configuration of the learning data for training the CNN-based model may be expressed below as Equation 3.

$$\{ {Y}^{[ d ]} , {τ}_{Delay}^{[ d ]} \} , d = 1 , 2 , … , D \qquad [ Equation 3 ]$$

Y=Allocated DMRS Channel matrix
τ_{Delay}=Delay spread level
D=Number of data samples

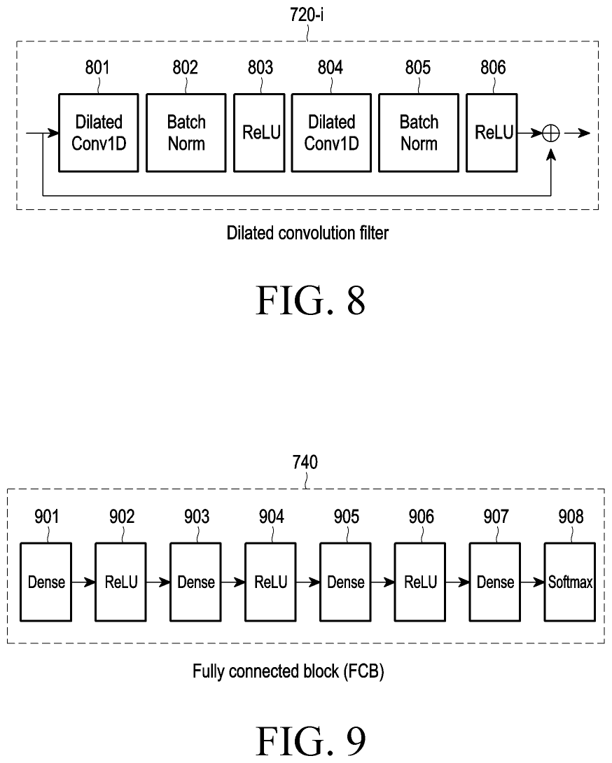

FIG. 8 illustrates an example of the configuration of a dilated convolution block (DCB) included in the CNN-based model of FIG. 7, which illustrates an example of the configuration of an i-th DCB720-i of the plurality of DCBs 720-1, . . . , 720-i, . . . , and 720-N (where 0≤i≤n and i is an integer) included in the convolution filter block 720 of FIG. 7.

In an embodiment, the plurality of DCBs 720-1, . . . , 720-i, . . . , and 720-N may have the same configuration as the i-th DCB 720-i of FIG. 8. In an embodiment, at least some blocks among the plurality of DCBs 720-1, . . . , 720-i, . . . , and 720-N may have a different configuration from that of the i-th DCB 720-i. According to an embodiment, having different configurations may be understood, for example, as a connection structure of a dilated Cove1D, a batch norm, and an ReLU in a DCB being repeated a different number of times in an embodiment. For example, the DCB 720-1 may have a structure in which the connection structure of the dilated Cove1D, the batch norm, and the ReLU is repeated twice as in the example of FIG. 8, while DCB 720-2 may have a structure in which the connection structure of the dilated Cove1D, the batch norm, and the ReLU is repeated more than twice. The number of times the connection structure of the dilated Cove1D, the batch norm, and the ReLU is repeated in each DCB may be configured variably using a predetermined structure or according to iterative training.

Referring to FIG. 8, the DCB may include dilated convolution layers 1D (dilated Conv1D) 801 and 804, batch normalizations (batch norms) 802 and 805, and rectified linear units (ReLU) 803 and 806 dilated to the plurality of blocks. Each of the dilated 1D convolution layers (dilated Conv1D) 801 and 804 is a convolution filter that performs a convolution operation for pattern learning to estimate a channel characteristic for input 1D data. Each of the dilated 1D convolution layers (dilated Cove1D) 801 and 804 operates based on a dilation rate, like the dilated convolution filter 630 of FIG. 6. Each of the batch normalizations 802 and 805 is a block that normalizes distribution of input data for estimating a channel characteristic. Each of the rectified linear units (ReLU) 803 and 806 is a block that outputs 0 in an example case in which input value is less than 0 and outputs the input value as it is when the input value is greater than 0 in order to process a nonlinear function, such as a channel characteristic, with low complexity. In FIG. 8, input data of the DCB is combined with output data of the rectified linear unit (ReLU) 806 into output data of the DCB. The example of FIG. 8 shows that a structure in which the dilated Cove1D, the batch norm, and the ReLU are sequentially connected is repeated twice. In an embodiment, the connection structure of the dilated Cove1D, the batch norm, and the ReLU may be repeated once or a plurality of times.

FIG. 9 illustrates an example of the configuration of the fully connected block (FCB) included in the CNN-based model of FIG. 7.

Referring to FIG. 9, the FCB 740 may include dense blocks 901, 903, 905, and 907, rectified linear units (ReLU) 902, 904, and 906, and a softmax908 as a plurality of blocks. According to an embodiment, the rectified linear units 902, 904, and 906 may be optionally included. Each of the dense blocks 901, 903, 905, and 907 performs an analysis to classify input data (e.g., channel characteristic data) by delay spread level, and each of the rectified linear unit (ReLU) 902, 904, and 906 is a block that outputs 0 in an example case in which input value is less than 0 and outputs the input value as it is, in an example case in which the input value is greater than 0 in order to process a nonlinear function, such as a channel characteristic, with low complexity. The softmax 908 receives analyzed channel characteristic data, and outputs a probability value that the channel characteristic data belongs to a preset delay spread level. The example of FIG. 9 shows a structure in which the dense and the ReLU are sequentially connected is repeated. In an embodiment, the connection structure of the dense and the ReLU may be repeated once or a plurality of times. The softmax 908 is included at the end of the FCB 740.

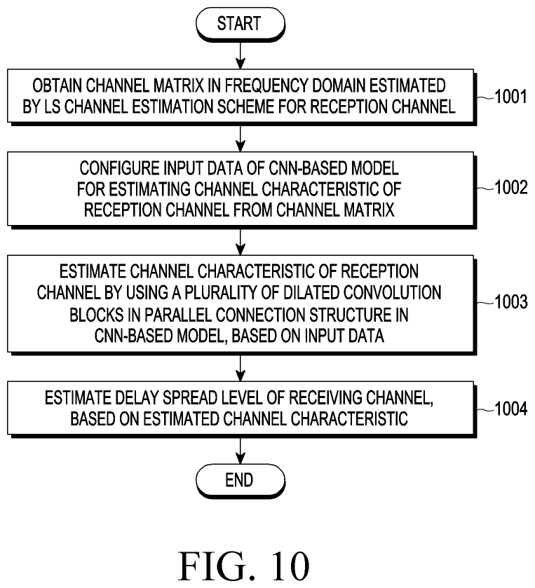

FIG. 10 illustrates an example of a method for estimating a channel characteristic by using a CNN-based model to estimate delay spread according to an embodiment of the disclosure. Here, the CNN-based model may be the CNN-based model illustrated according to an example embodiment in FIG. 7.

Referring to FIG. 10, in operation 1001, the method may include obtaining a channel matrix in a frequency domain estimated by the LS channel estimation scheme for a reception channel. For example, the communication device may obtain a channel matrix in a frequency domain estimated by the LS channel estimation scheme for a reception channel.

In operation 1002, the method may include configuring input data of the CNN-based model. For example, the communication device may configure input data of the CNN-based model of FIG. 7 to estimate a channel characteristic of the reception channel from the channel matrix.

In operation 1003, the method may include estimating the channel characteristic of the reception channel by using a plurality of dilated convolution blocks (DCBs) in a parallel connection structure in the CNN-based model, based on the input data. For example, the communication device may estimate the channel characteristic of the reception channel by using the plurality of dilated convolution blocks (DCBs) in the parallel connection structure in the CNN-based model, based on the input data.

In operation 1004, the method may include estimating the delay spread level of the reception channel, based on the estimated channel characteristic. For example, the communication device may estimate the delay spread level of the reception channel, based on the estimated channel characteristic.

For example, the communication device using the CNN-based model of FIG. 7 may calculate the probability value of delay spread of the reception channel to distinguish the delay spread level according to a preset range, and may then configure an input data set in operation 1002 to estimate the delay spread level. The delay spread level estimated in operation 1004 is a parameter that is configurable according to a communication scenario, and may be configured to four levels as in the example of Table 1. In the disclosure, the delay spread level is not limited to the example of Table 1, and the degree to which the delay spread level is distinguished may be increased or decreased.

A loss function of the CNN-based model according to an embodiment of the disclosure may employ, for example, a categorical cross entropy function used in multi-classification. The loss function & may be expressed below as Equation 4.

$$L = - {\sum }_{k = 1}^{K} {τ}_{Delay , k} log ( {\hat{τ}}_{Delay , k} ) \qquad [ Equation 4 ]$$

In Equation 4, τ_{Delay,k} denotes a kth element of a vector resulting from one-hot encoding of a labeled τ_{Delay}, and \hat{τ}_{Delay,k} denotes a kth element of a final output vector of the CNN-based model. One-hot encoding refers to a process of converting categorical data into numerical data, such as binary data. In the disclosure, since learning is performed to predict a total of four delay diffusion levels as in the example of Table 1, K=4 may be configured. The model parameter may be updated until the training loss (e.g., validation loss) of validation data for validating learning of the CNN-based model converges.

According to an embodiment, the method may further include configuring parameters for communication between a UE and a base station based on the estimated delay spread level and performing a communication by the UE based on the configured parameters.

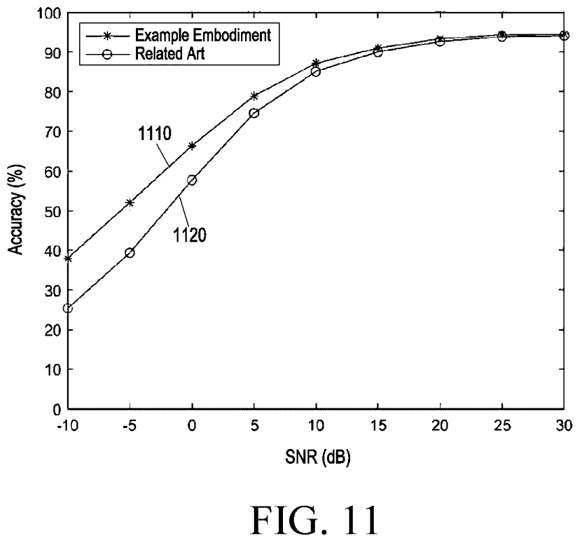

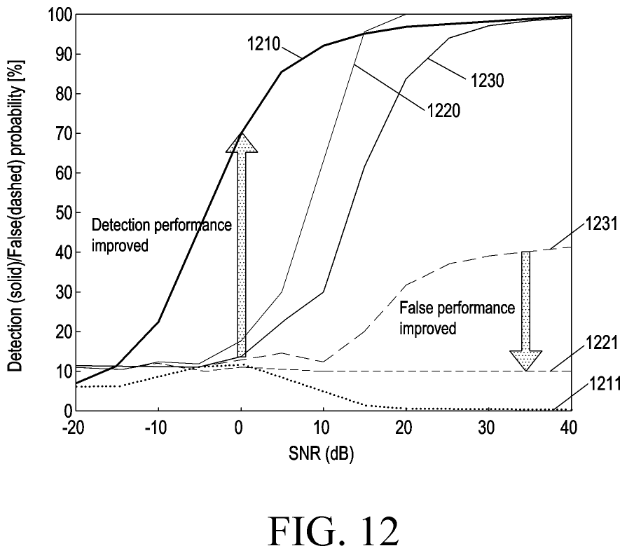

FIG. 11 and FIG. 12 illustrate examples of simulation results of delay spread estimation performance using a CNN-based model according to an embodiment of the disclosure.

A simulation environment of FIG. 11 and FIG. 12 is, for example, a physical uplink shared channel (PUSCH) 12-resource block (RB) environment in the 3GPP NR standard, and the simulation results are obtained by configuring a learning and test data set according to a normalized delay profile of tapped delay line (TDL)-A, TDL-B, TDL-C, TDL-D, and TDL-E channels defined in Table 7.7.2 of 3GPP TR 38.901Rel 16.

In FIG. 11, reference number 1110 shows the accuracy of delay spread estimation when using the CNN-based model according to an example embodiment illustrated in FIG. 7, and reference number 1120 shows the accuracy of delay spread estimation when using the related art CNN-based model of FIG. 4.

For example, FIG. 11 shows the result of comparing the performance of a residual network (ResNet) structure in the related art CNN-based model of FIG. 4 and the performance of a ResNet structure in the CNN-based model according to an example embodiment illustrated in FIG. 7. In FIG. 11, the accuracy refers to the probability that the delay spread level of a reception channel is accurately determined when a received LS channel-estimated signal is input to the CNN-based model. Referring to FIG. 11, when using the dilated convolution blocks in the parallel connection structure in the CNN-based model of FIG. 7 according to an embodiment of the disclosure, it may be identified that better performance is achieved overall in all SNRs compared to when using the convolution blocks in the serial connection structure in the related art CNN-based model of FIG. 4. For example, the performance is superior in a [−10, 0 dB] range where the SNR is relatively low, which shows that the proposed neural network structure is suitable for estimating a channel characteristic in a situation with heavy noise signals. That is, the accuracy of the delay spread estimation according to an embodiment of the disclosure shows an improved result.

Referring to FIG. 12, reference numbers 1210 and 1211 respectively show accurate detection success performance and detection failure performance of a delay spread level when using the CNN-based model according to an example embodiment illustrated in FIG. 7, and reference numbers 1220 and 1221 respectively show detection success performance and detection failure performance of a delay spread level in an example of a related art method for detecting a delay spread level in the frequency domain without using an AI model. Reference numbers 1230 and 1231 in FIG. 12 respectively show accurate detection success performance and detection failure performance of a delay spread level in an example of a related art method for detecting a delay spread level in the time domain without using an AI model. It may be shown that the delay spread level detection performance of the CNN-based model according to an embodiment of the disclosure is improved compared to the related methods not using the CNN-based model.

TABLE 2

| | RELATED ART | EXAMPLE EMBODIMENT |
|---|---|---|
| Parameters | 22,932 | 21,908 |
| FLOPs(K) | 1419.0 | 769.208 |

Table 2 shows comparison between the computational complexity of the related art CNN-based model of FIG. 4 and that of the CNN-based model of FIG. 7 according to an example embodiment of the disclosure. In Table 2, the number of parameters refers to the total number of optimized model parameters of a trained neural network, and floating point operations per second (FLOPs) refers to the quantity of floating point operations that need to be performed per second for inference after learning.

As summarized above in Table 2, the CNN-based model according to an example embodiment illustrated in FIG. 7 may achieve excellent performance with a small quantity of computations, thus identifying that the neural network structure proposed in the disclosure is a structure suitable for a wireless communication system where real-time processing is important.

According to an embodiment, a method performed by a communication device using an LS channel estimation scheme in a wireless communication system may include obtaining a channel matrix in a frequency domain estimated by the least square (LS) channel estimation method for a reception channel, configuring input data of a convolution neural network (CNN)-based model for estimating a channel characteristic of the reception channel from the channel matrix, estimating the channel characteristic of the reception channel by using a plurality of dilated convolution blocks with a parallel connection structure in the CNN-based model, based on the input data, and estimating a delay spread level of the reception channel, based on the estimated channel characteristic.

According to an embodiment, the method may further include performing iterative training of the CNN-based model by using the plurality of dilated convolution blocks with the parallel connection structure.

According to an embodiment, in the method, the iterative training may be terminated in case that validation loss of the CNN-based model converges.

According to an embodiment, in the method, the channel characteristic may be extracted through a plurality of receptive fields of the plurality of dilated convolution blocks.

According to an embodiment, in the method, different dilation rates indicating distribution degree of a receptive field in the frequency domain may be configured for the plurality of dilated convolution blocks.

According to an embodiment, in the method, the configuring of the input data may further include performing a one-dimensional (1D) pointwise convolution operation for resizing of the input data, based on a number of the plurality of convolution blocks.

According to an embodiment, in the method, an active mode of the communication device may include a training mode and an operation mode, and the method may further include performing iterative training of estimation of the channel characteristic and estimation of the delay spread level in the training mode, and estimating the channel characteristic of the reception channel by using the CNN-based model trained in the operation mode and estimating the delay spread level, based on the estimated channel characteristic in case that the iterative training is performed a predetermined number of times.

According to an embodiment, the method may further include performing additional training of the CNN-based model by using actual channel data collected by the communication device as input data in the operation mode.

According to an embodiment, in the method, the delay spread level may be classified into a plurality of levels depending on delay spread degree.

According to an embodiment, the method may further include concatenating channel characteristic data of the reception channel output from the plurality of dilated convolution blocks, and outputting a probability value that the channel characteristic of the reception channel belongs to the delay spread level, based on the channel characteristic data.

According to an embodiment, a communication device may include one or more processors including processing circuitry, and memory storing instructions that, when executed by the one or more processors individually or collectively, cause the communication device to obtain a channel matrix in a frequency domain estimated by the least square (LS) channel estimation method for a reception channel, configure input data of the CNN-based model for estimating a channel characteristic of the reception channel from the channel matrix, estimate the channel characteristic of the reception channel by using a plurality of dilated convolution blocks with a parallel connection structure, based on the input data, and estimate a delay spread level of the reception channel, based on the estimated channel characteristic.

FIG. 13 illustrates a structure of a communication device in a wireless communication system according to an embodiment of the disclosure. The embodiments in FIGS. 5 to 12 may be applied to a base station in FIG. 13.

The base station in FIG. 13 may include a processor 1330, a transceiver 1310, and memory 1320. The processor 1330, the transceiver 1310, and the memory 1320 in FIG. 134 may be operated according to at least one of the embodiments in FIGS. 5 to 12. However, components of the base station are not limited to the above-described example. For example, the base station may include a larger or smaller number of components than the above-described components. In addition, the processor 1330, the transceiver 1310, and the memory 1320 may be implemented in the form of a single chip. The transceiver 1310 refers to a base station receiver and a base station transmitter as a whole, and may transmit/receive signals with UEs or other base stations. The transmitted/received signals may include at least one of control information and data. According to an embodiment, the transceiver 1310 may include wired/wireless transceivers, and may include various components for transmitting/receiving signals. The transceiver 1310 may receive signals, output the same to the processor 1330, and transmit signals output from the processor 1330.

Furthermore, the transceiver 1310 may receive communication signals, output the same to the processor 1330, and transmit signals output from the processor 1330 to other base stations through a network. The memory 1320 may store programs and data necessary for operations of the base station according to at least one of the embodiments in FIGS. 5 to 12. In addition, the memory 1320 may store control information or data included in a signal acquired by the base station. The memory 1320 may include storage media such as a ROM, a RAM, a hard disk, a CD-ROM, and a DVD, or a combination of storage media. The processor 1330 may control a series of processes so that the base station can operate according to at least one of the embodiments in FIGS. 5 to 12.

According to one or more embodiments, methods and/or operations described above may be implemented by hardware, software, or a combination of hardware and software.

In an example case in which the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a communication device in a wireless communication system, the method comprising:
obtaining, for a reception channel, a channel matrix in a frequency domain estimated using a least square (LS) channel estimation scheme;
configuring input data of a convolution neural network (CNN)-based model for estimating a channel characteristic of the reception channel from the channel matrix;
estimating, based on the input data, the channel characteristic of the reception channel by using a plurality of dilated convolution blocks with a parallel connection structure in the CNN-based model; and
estimating, based on the estimated channel characteristic, a delay spread level of the reception channel.

2. The method of claim 1, further comprising performing iterative training of the CNN-based model by using the plurality of dilated convolution blocks with the parallel connection structure.

3. The method of claim 2, wherein the performing of the iterative training is terminated based on convergence of validation loss of the CNN-based model.

4. The method of claim 1, wherein the method of estimating the channel characteristic comprises extracting the channel characteristic through a plurality of receptive fields of the plurality of dilated convolution blocks.

5. The method of claim 1, wherein the plurality of dilated convolution blocks with the parallel connection structure are configured based on different dilation rates indicating distribution degree of a receptive field in the frequency domain.

6. The method of claim 1, wherein the configuring of the input data further comprises performing a one-dimensional (1D) pointwise convolution operation for resizing of the input data, based on a number of the plurality of dilated convolution blocks.

7. The method of claim 1, wherein an active mode of the communication device comprises a training mode and an operation mode, and
wherein the method further comprises:
in the training mode:
performing iterative training of estimating the channel characteristic and estimating the delay spread level; and
in the operation mode:
estimating the channel characteristic of the reception channel by using the CNN-based model trained and estimating the delay spread level based on the estimated channel characteristic in case that the iterative training is performed a predetermined number of times.

8. The method of claim 7, further comprising performing additional training of the CNN-based model based on actual channel data collected by the communication device as input data in the operation mode.

9. The method of claim 1, wherein the delay spread level is classified into a plurality of levels depending on delay spread degree.

10. The method of claim 1, further comprising:
concatenating channel characteristic data of the reception channel output from the plurality of dilated convolution blocks; and
outputting a probability value that the channel characteristic of the reception channel belongs to the delay spread level, based on the channel characteristic data.

11. A communication device in a wireless communication system, the communication device comprising:
one or more processors including processing circuitry; and
memory storing instructions that, when executed by the one or more processors individually or collectively, cause the communication device to:
obtain, for a reception channel, a channel matrix in a frequency domain estimated using least square (LS) channel estimation method,
configure input data of a convolution neural network (CNN)-based model for estimating a channel characteristic of the reception channel from the channel matrix,
estimate, based on the input data, the channel characteristic of the reception channel by using a plurality of dilated convolution blocks with a parallel connection structure, based on the input data, and
estimate, based on the estimated channel characteristic, a delay spread level of the reception channel.

12. The communication device of claim 11, wherein the instructions, when executed by the one or more processors individually or collectively, further cause the communication device to:
perform iterative training of the CNN-based model by using the plurality of dilated convolution blocks with the parallel connection structure.

13. The communication device of claim 12, wherein the instructions, when executed by the one or more processors individually or collectively, further cause the communication device to:
terminate the iterative training based on convergence of validation loss of the CNN-based model.

14. The communication device of claim 11, wherein the instructions, when executed by the one or more processors individually or collectively, further cause the communication device to:
extract the channel characteristic through a plurality of receptive fields of the plurality of dilated convolution blocks.

15. The communication device of claim 11, wherein the instructions, when executed by the one or more processors individually or collectively, further cause the communication device to:
configure different dilation rates indicating distribution degree of a receptive field in the frequency domain for the plurality of dilated convolution blocks.

16. The communication device of claim 11, wherein the instructions, when executed by the one or more processors individually or collectively, further cause the communication device to:
perform a one-dimensional (1D) pointwise convolution operation for resizing of the input data, based on a number of the plurality of dilated convolution blocks.

17. The communication device of claim 11, wherein an active mode of the communication device comprises a training mode and an operation mode, and
wherein the instructions, when executed by the one or more processors individually or collectively, further cause the communication device to:
in the training mode:
perform iterative training of estimating the channel characteristic and estimating the delay spread level in the training mode; and
in the operation mode:
estimate the channel characteristic of the reception channel by using the CNN-based model trained and estimate the delay spread level, based on the estimated channel characteristic when the iterative training is performed a predetermined number of times.

18. The communication device of claim 11, wherein the delay spread level is classified into a plurality of levels depending on delay spread degree.

19. The communication device of claim 11, wherein the instructions, when executed by the one or more processors individually or collectively, further cause the communication device to:
concatenate channel characteristic data of the reception channel output from the plurality of dilated convolution blocks; and
output a probability value that the channel characteristic of the reception channel belongs to the delay spread level, based on the channel characteristic data.

20. The communication device of claim 17, wherein the instructions, when executed by the one or more processors individually or collectively, further cause the communication device to:
perform additional training of the CNN-based model by using actual channel data collected by the communication device as input data in the operation mode.
